(19) United States
(12) Patent Application Publication
(10) Pub. No.: US 2013/0013875 A1
(43) Pub. Date: Jan. 10, 2013

(54) METHOD AND SYSTEM FOR AUTOMATICALLY SAVING A FILE

(75) Inventors: David Andrew Brown, Waterloo (CA); Michael Stephen Brown, Waterloo (CA); Terrill Mark Dent, Waterloo (CA)

(73) Assignee: Research In Motion Limited, Waterloo, ON (CA)

(21) Appl. No.: 13/634,831

(22) PCT Filed: Apr. 5, 2011
(86) PCT No.: PCT/CA2011/000389

§ 371 Date: Sep. 13, 2012

Related U.S. Application Data
(60) Provisional application No. 61/386,684, filed on Sep. 27, 2010.

(51) Int. Cl. G06F 12/16

(52) U.S. Cl. 711/162; 711/E12.103

(57) ABSTRACT

Described herein are a method, system, and computer readable medium for automatically saving a file. A save score for the file is determined and compared against a save threshold. The save score is determined from a combination of autosave indicators indicative of whether to immediately autosave the file. Each of the autosave indicators that adjust the save score increases or decreases the likelihood that the file will be automatically saved. If the comparison indicates that the file should be automatically saved, the file is automatically saved; otherwise, the file is not automatically saved. The save score can take into consideration factors such as the number of dirty characters in the file and the time at which the file was last saved. Utilizing the save score reduces the number of saves performed when only immaterial changes have been made to the file, which helps preserve system resources such as battery life.

### TECHNICAL FIELD

The present disclosure is directed at a method and system for automatically saving a file.

### BACKGROUND

Automatically saving (“autosaving”) a file refers to saving the file without requiring the user to explicitly command that the file be saved. Autosaving is useful in that it facilitates frequent storing of data, which helps to ensure that changes made to the file are preserved. Detrimentally, however, autosaving utilizes system resources such as processor cycles and, in mobile devices, battery power. Frequently autosaving can consequently reduce mobile device battery life and decrease system responsiveness.

### BRIEF DESCRIPTION OF THE DRAWINGS

For a better understanding of the various example embodiments described herein and to show more clearly how they may be carried into effect, reference will now be made, by way of example only, to the accompanying drawings which show at least one example embodiment and in which:

FIG. 1 is a block diagram of an example embodiment of a mobile device;

FIG. 2 is a block diagram of an example embodiment of a communication subsystem component of the mobile device of FIG. 1;

FIG. 3 is an example block diagram of a node of a wireless network;

FIG. 4 is a block diagram illustrating components of a host system in one example configuration for use with the wireless network of FIG. 3 and the mobile device of FIG. 1;

FIG. 5 illustrates selected modules of a memory of the mobile device of FIG. 1, according to a first example embodiment;

FIG. 6 is a flowchart depicting how a file is saved in response to a user request, according to the first example embodiment;

FIG. 7 is a flowchart depicting various example triggers that initiate performance of an example method for automatically saving a file, according to the first example embodiment;

FIG. 8 is a flowchart depicting the example method for automatically saving a file, according to the first example embodiment; and

FIG. 9 is a flowchart describing how a save score, for use in the example method depicted in FIG. 8, is determined, according to the first example embodiment.

### DETAILED DESCRIPTION

According to a first aspect, there is provided a method for automatically saving a file. The method includes determining a save score for the file, comparing the save score to a save threshold to determine whether the file should be automatically saved, and saving the file when the file should be automatically saved. The save score may be determined from a combination of autosave indicators that are indicative of whether to immediately autosave the file, and each of the autosave indicators that adjust the save score increases or decreases the likelihood that the file will be automatically saved.

The file may be edited using a first mobile device that is connected to a wireless network via a second mobile device, and the file may be saved on to the second mobile device. The first mobile device may be a tablet computer and the second mobile device may be a smart-phone. The first mobile device may be connected to a wireless network, such as the Internet, via the second mobile device.

The autosave indicator may be determined by multiplying together an attribute by a multiplier. The attribute, and consequently the autosave indicator, may be indicative of the document itself (e.g.: whether material changes have been made to the file), or may be indicative of the environment in which the document is being edited (e.g.: the likelihood that the environment in which the file is being edited is unstable and could result in data losses). The multiplier can increase or decrease the effect of the attribute on the autosave indicator and, consequently, the save score by amplifying the effect of the attribute.

The save score can be scaled by the autosave indicator, or incremented or decremented by the autosave indicator. Furthermore, the save score can be adjusted in a different way by the autosave indicator, such as by being assigned the value of a function that depends on the autosave indicator.

The autosave indicator can be any one or more of independent of a time at which the file was previously saved; indicative of a number of characters edited in the file since the file was previously saved; indicative of the type of the file; indicative of a number of characters edited (added, deleted, moved, or any combination thereof) in the file since the file was previously saved; indicative of a number of return characters edited in the file since the file was previously saved; indicative of whether the file is in the foreground of the user interface in which the file can be edited; indicative of the size of the file; indicative of a typing speed of a user over a certain period of time; indicative of a time at which the file was last saved; indicative of a total age of the file; and indicative of an amount of time that has passed since the last keystroke.

Prior to saving the file, it may be determined whether any dirty characters at all are present in the file, or, when the mobile device is saving the file to the second mobile device, whether the mobile device is presently connected to the second mobile device. In the event that no dirty characters are present or there is no network connection, the file may not be saved.

Saving the file may involve saving only changes made to the file since the file was last saved.

The save score may be determined any one or more of periodically; after detection of a keystroke that alters the file; and when the file switches between the background and the foreground of the user interface.

According to another aspect, there is provided a system for automatically saving a file. The system includes a main processor and a memory communicatively coupled to the main processor. The file may be saved on to the memory. Additionally, the memory has encoded on it statements and instructions to configure the main processor to carry out a method according to any of the foregoing aspects. The system may also include a communication subsystem that is communicable with a mobile device on to which the file may be saved.

According to another aspect, there is provided a computer readable medium that has encoded on it statements and instructions to configure a processor to carry out a method according to any of the foregoing aspects.

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

The example embodiments described herein generally relate to a mobile wireless communication device, also referred to herein as a mobile device or a communication device, which can be configured according to an IT policy. It should be noted that the term IT policy, in general, refers to a collection of IT policy rules, in which the IT policy rules can be defined as being either grouped or non-grouped and global or per-user. The terms grouped, non-grouped, global and per-user are defined further below. Examples of applicable communication devices include pagers, cellular phones, cellular smart-phones, wireless organizers, personal digital assistants, computers, laptops, handheld wireless communication devices, tablet computers, wirelessly enabled notebook computers and the like.

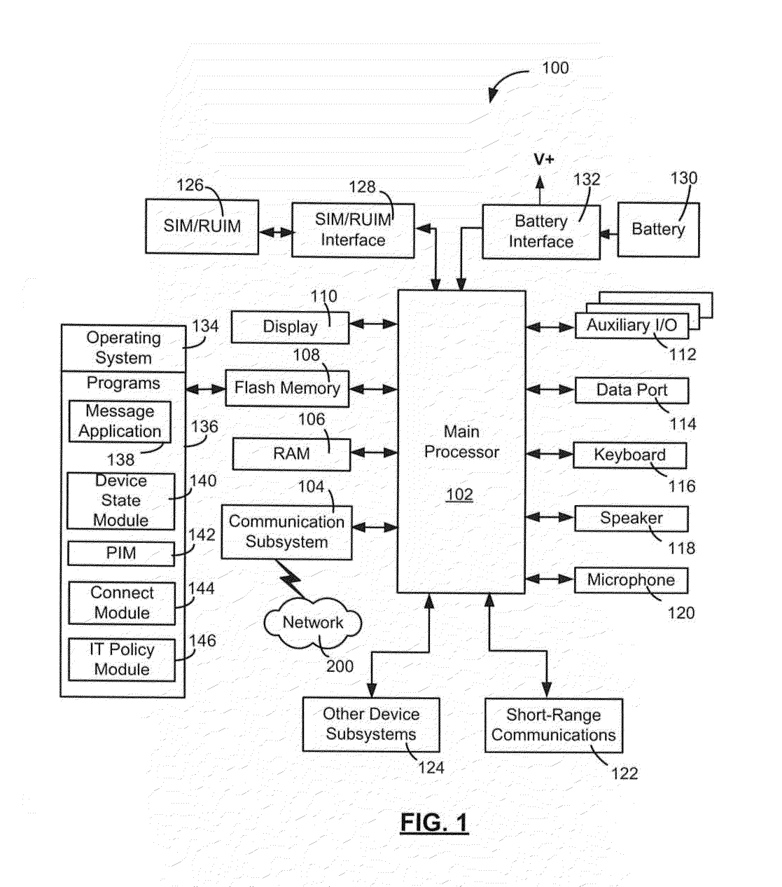

The mobile device is a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities). To aid the reader in understanding the structure of the mobile device and how it communicates with other devices and host systems, reference will now be made to FIGS. 1 through 4.

Referring first to FIG. 1, shown therein is a block diagram of an example embodiment of a mobile device 100. The mobile device 100 includes a number of components such as a main processor 102 that controls the overall operation of the mobile device 100. Communication functions, including data and voice communications, are performed through a communication subsystem 104. The communication subsystem 104 receives messages from and sends messages to a wireless network 200. In this example embodiment of the mobile device 100, the communication subsystem 104 is configured in accordance with the Global System for Mobile Communication (GSM) and General Packet Radio Services (GPRS) standards. The GSM/GPRS wireless network is used worldwide, and in recent years Enhanced Data GSM Environment (EDGE) and Universal Mobile Telecommunications Service (UMTS) have also been adopted. New standards, such as Long Term Evolution (LTE) are still being developed, but it is believed that they will have similarities to the network behavior described herein, and it will also be understood by persons skilled in the art that the example embodiments described herein are intended to use any other suitable standards that are developed in the future. The wireless link connecting the communication subsystem 104 with the wireless network 200 represents one or more different Radio Frequency (RF) channels, operating according to defined protocols specified for GSM/GPRS communications. With newer network protocols, these channels are capable of supporting both circuit switched voice communications and packet switched data communications.

Although the wireless network 200 associated with mobile device 100 is a GSM/GPRS wireless network in one example implementation, other wireless networks may also be associated with the mobile device 100 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), third-generation (3G) networks like EDGE and UMTS, and fourth-generation (4G) networks. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems.

The main processor 102 also interacts with additional subsystems such as a Random Access Memory (RAM) 106, a flash memory 108, a display 110, an auxiliary input/output (I/O) subsystem 112, a data port 114, a keyboard 116, a speaker 118, a microphone 120, short-range communications 122 and other device subsystems 124.

Some of the subsystems of the mobile device 100 perform communication-related functions, whereas other subsystems may provide “resident” or on-device functions. By way of example, the display 110 and the keyboard 116 may be used for both communication-related functions, such as entering a text message for transmission over the network 200, and device-resident functions such as a calculator or task list.

The mobile device 100 can send and receive communication signals over the wireless network 200 after required network registration or activation procedures have been completed. Network access is associated with a subscriber or user of the mobile device 100. To identify a subscriber, the mobile device 100 requires a SIM/RUIM card 126 (i.e. Subscriber Identity Module or a Removable User Identity Module) to be inserted into a SIM/RUIM interface 128 in order to communicate with a network. The SIM card or RUIM 126 is one type of a conventional “smart card” that can be used to identify a subscriber of the mobile device 100 and to personalize the mobile device 100, among other things. Without the SIM card 126, the mobile device 100 is not fully operational for communication with the wireless network 200. By inserting the SIM card/RUIM 126 into the SIM/RUIM interface 128, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 126 includes a processor and memory for storing information. Once the SIM card/RUIM 126 is inserted into the SIM/RUIM interface 128, it is coupled to the main processor 102. In order to identify the subscriber, the SIM card/RUIM 126 can include some user parameters such as an International Mobile Subscriber Identity (IMSI). An advantage of using the SIM card/RUIM 126 is that a subscriber is not necessarily bound by any single physical mobile device. The SIM card/RUIM 126 may store additional subscriber information for a mobile device as well, including datebook (or calendar) information and recent call information. Alternatively, user identification information can also be programmed into the flash memory 108.

The mobile device 100 is a battery-powered device and includes a battery interface 132 for receiving one or more rechargeable batteries 130. In at least some example embodiments, the battery 130 can be a smart battery with an embedded microprocessor. The battery interface 132 is coupled to a regulator (not shown), which assists the battery 130 in providing power V+ to the mobile device 100. Although current technology makes use of a battery, future technologies such as micro fuel cells may provide the power to the mobile device 100.

The mobile device 100 also includes an operating system 134 and software modules 136 to 146 which are described in more detail below. The operating system 134 and the software modules 136 to 146 that are executed by the main processor 102 are typically stored in a persistent store such as the flash memory 108, which may alternatively be a read-only memory (ROM) or similar storage element (not shown). Those skilled in the art will appreciate that portions of the operating system 134 and the software modules 136 to 146, such as specific device applications, or parts thereof, may be temporarily loaded into a volatile store such as the RAM 106. Other software modules can also be included, as is well known to those skilled in the art.

The subset of software applications 136 that control basic device operations, including data and voice communication applications, will normally be installed on the mobile device 100 during its manufacture. Other software applications include a message application 138 that can be any suitable software program that allows a user of the mobile device 100 to send and receive electronic messages. Various alternatives exist for the message application 138 as is well known to those skilled in the art. Messages that have been sent or received by the user are typically stored in the flash memory 108 of the mobile device 100 or some other suitable storage element in the mobile device 100. In at least some example embodiments, some of the sent and received messages may be stored remotely from the device 100 such as in a data store of an associated host system that the mobile device 100 communicates with.

The software applications can further include a device state module 140, a Personal Information Manager (PIM) 142, and other suitable modules (not shown). The device state module 140 provides persistence, i.e. the device state module 140 ensures that important device data is stored in persistent memory, such as the flash memory 108, so that the data is not lost when the mobile device 100 is turned off or loses power.

The PIM 142 includes functionality for organizing and managing data items of interest to the user, such as, but not limited to, e-mail, contacts, calendar events, voice mails, appointments, and task items. A PIM application has the ability to send and receive data items via the wireless network 200. PIM data items may be seamlessly integrated, synchronized, and updated via the wireless network 200 with the mobile device subscriber's corresponding data items stored and/or associated with a host computer system. This functionality creates a mirrored host computer on the mobile device 100 with respect to such items. This can be particularly advantageous when the host computer system is the mobile device subscriber's office computer system.

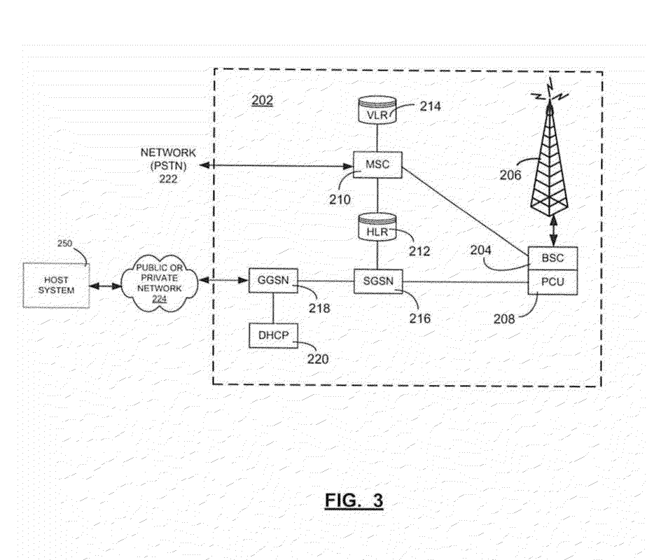

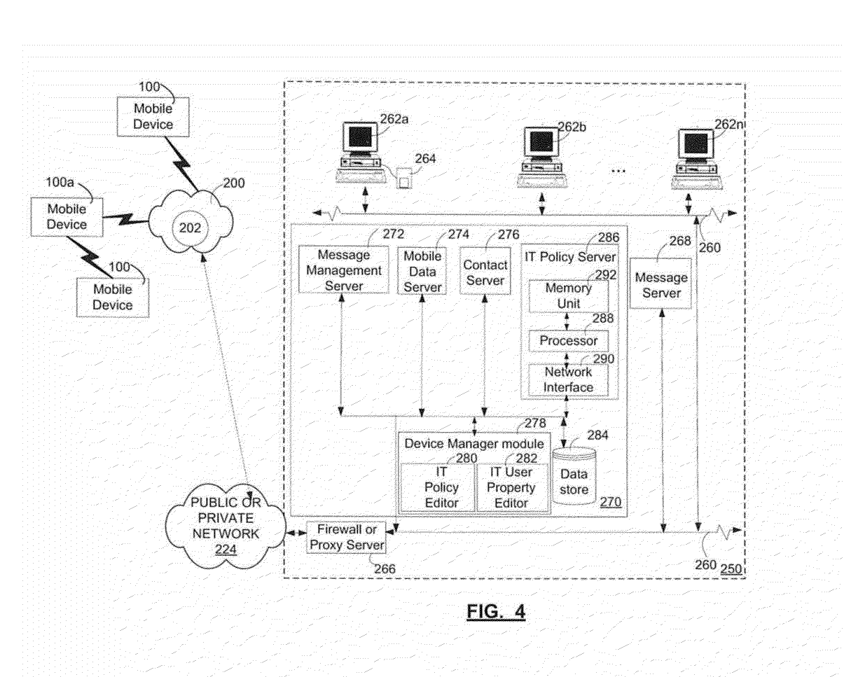

The mobile device 100 also includes a connect module 144, and an IT policy module 146. The connect module 144 implements the communication protocols that are required for the mobile device 100 to communicate with the wireless infrastructure and any host system, such as an enterprise system, that the mobile device 100 is authorized to interface with. Examples of a wireless infrastructure and an enterprise system are given in FIGS. 3 and 4, which are described in more detail below.

The connect module 144 includes a set of APIs that can be integrated with the mobile device 100 to allow the mobile device 100 to use any number of services associated with the enterprise system. The connect module 144 allows the mobile device 100 to establish an end-to-end secure, authenticated communication pipe with the host system. A subset of applications for which access is provided by the connect module 144 can be used to pass IT policy commands from the host system to the mobile device 100. This can be done in a wireless or wired manner. These instructions can then be passed to the IT policy module 146 to modify the configuration of the device 100. Alternatively, in some cases, the IT policy update can also be done over a wired connection.

The IT policy module 146 receives IT policy data that encodes the IT policy. The IT policy module 146 then ensures that the IT policy data is authenticated by the mobile device 100. The IT policy data can then be stored in the flash memory 106 in its native form. After the IT policy data is stored, a global notification can be sent by the IT policy module 146 to all of the applications residing on the mobile device 100. Applications for which the IT policy may be applicable then respond by reading the IT policy data to look for IT policy rules that are applicable.

The IT policy module 146 can include a parser (not shown), which can be used by the applications to read the IT policy rules. In some cases, another module or application can provide the parser. Grouped IT policy rules, described in more detail below, are retrieved as byte streams, which are then sent (recursively, in a sense) into the parser to determine the values of each IT policy rule defined within the grouped IT policy rule. In at least some example embodiments, the IT policy module 146 can determine which applications are affected by the IT policy data and send a notification to only those applications. In either of these cases, for applications that aren't running at the time of the notification, the applications can call the parser or the IT policy module 146 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 146 sends an acknowledgement back to the host system to indicate that the IT policy data was received and successfully applied.

Other types of software applications can also be installed on the mobile device 100. These software applications can be third party applications, which are added after the manufacture of the mobile device 100. Examples of third party applications include games, calculators, utilities, etc.

The additional applications can be loaded onto the mobile device 100 through at least one of the wireless network 200, the auxiliary I/O subsystem 112, the data port 114, the short-range communications subsystem 122, or any other suitable device subsystem 124. This flexibility in application installation increases the functionality of the mobile device 100 and may provide enhanced on-device functions, communication-related functions, or both. For example, secure communication applications may enable electronic commerce functions and other such financial transactions to be performed using the mobile device 100.

The data port 114 enables a subscriber to set preferences through an external device or software application and extends the capabilities of the mobile device 100 by providing for information or software downloads to the mobile device 100 other than through a wireless communication network. The alternate download path may, for example, be used to load an encryption key onto the mobile device 100 through a direct and thus reliable and trusted connection to provide secure device communication.

The data port 114 can be any suitable port that enables data communication between the mobile device 100 and another computing device. The data port 114 can be a serial or a parallel port. In some instances, the data port 114 can be a USB port that includes data lines for data transfer and a supply line that can provide a charging current to charge the battery 130 of the mobile device 100.

The short-range communications subsystem 122 provides for communication between the mobile device 100 and different systems or devices, without the use of the wireless network 200. For example, the subsystem 122 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 104 and input to the main processor 102. The main processor 102 will then process the received signal for output to the display 110 or alternatively to the auxiliary I/O subsystem 112. A subscriber may also compose data items, such as e-mail messages, for example, using the keyboard 116 in conjunction with the display 110 and possibly the auxiliary I/O subsystem 112. The auxiliary subsystem 112 may include devices such as: a touch screen, mouse, track ball, infrared fingerprint detector, a roller wheel with dynamic button pressing capability, or an optical trackpad with dynamic button pressing capability. The keyboard 116 is preferably an alphanumeric keyboard and/or telephone-type keypad. However, other types of keyboards may also be used. A composed item may be transmitted over the wireless network 200 through the communication subsystem 104.

For voice communications, the overall operation of the mobile device 100 is substantially similar, except that the received signals are output to the speaker 118, and signals for transmission are generated by the microphone 120. Alternative voice or audio I/O subsystems, such as a voice message recording subsystem, can also be implemented on the mobile device 100. Although voice or audio signal output is accomplished primarily through the speaker 118, the display 110 can also be used to provide additional information such as the identity of a calling party, duration of a voice call, or other voice call related information.

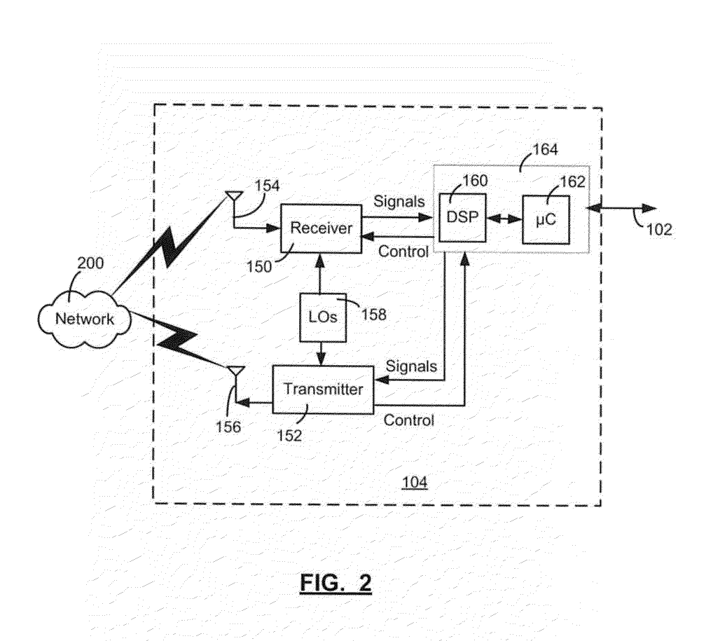

Referring now to FIG. 2, an example block diagram of the communication subsystem component 104 is shown. The communication subsystem 104 includes a receiver 150, a transmitter 152, as well as associated components such as one or more embedded or internal antenna elements 154 and 156, Local Oscillators (LOs) 158, and a processing module such as a Digital Signal Processor (DSP) 160 in conjunction with a microcontroller (μC) 162; collectively, the DSP 160 and μC 162 pair is a processing core hereinafter referred to as the “communication core” 164. The particular design of the communication subsystem 104 is dependent upon the communication network 200 with which the mobile device 100 is intended to operate. Thus, it should be understood that the design illustrated in FIG. 2 serves only as one example.

Signals received by the antenna 154 through the wireless network 200 are input to the receiver 150, which may perform such common receiver functions as signal amplification, frequency down conversion, filtering, channel selection, and analog-to-digital (ND) conversion. ND conversion of a received signal allows more complex communication functions such as demodulation and decoding to be performed in the communication core 164. In a similar manner, signals to be transmitted are processed, including modulation and encoding, by the communication core 164. These processed signals are input to the transmitter 152 for digital-to-analog (D/A) conversion, frequency up conversion, filtering, amplification and transmission over the wireless network 200 via the antenna 156. The communication core 164 not only processes communication signals, but also provides for receiver and transmitter control. For example, the gains applied to communication signals in the receiver 150 and the transmitter 152 may be adaptively controlled through automatic gain control algorithms implemented in the communication core 164.

The wireless link between the mobile device 100 and the wireless network 200 can contain one or more different channels, typically different RF channels, and associated protocols used between the mobile device 100 and the wireless network 200. An RF channel is a limited resource that must be conserved, typically due to limits in overall bandwidth and limited battery power of the mobile device 100.

When the mobile device 100 is fully operational, the transmitter 152 is typically keyed or turned on only when it is transmitting to the wireless network 200 and is otherwise turned off to conserve resources. Similarly, the receiver 150 is periodically turned off to conserve power until it is needed to receive signals or information (if at all) during designated time periods.

Referring now to FIG. 3, a block diagram of an example implementation of a node 202 of the wireless network 200 is shown. In practice, the wireless network 200 comprises one or more nodes 202. In conjunction with the connect module 144, the mobile device 100 can communicate with the node 202 within the wireless network 200. In the example implementation of FIG. 3, the node 202 is configured in accordance with General Packet Radio Service (GPRS) and Global Systems for Mobile (GSM) technologies. The node 202 includes a base station controller (BSC) 204 with an associated tower station 206, a Packet Control Unit (PCU) 208 added for GPRS support in GSM, a Mobile Switching Center (MSC) 210, a Home Location Register (HLR) 212, a Visitor Location Registry (VLR) 214, a Serving GPRS Support Node (SGSN) 216, a Gateway GPRS Support Node (GGSN) 218, and a Dynamic Host Configuration Protocol (DHCP) 220. This list of components is not meant to be an exhaustive list of the components of every node 202 within a GSM/GPRS network, but rather a list of components that are commonly used in communications through the network 200.

In a GSM network, the MSC 210 is coupled to the BSC 204 and to a landline network, such as a Public Switched Telephone Network (PSTN) 222 to satisfy circuit switched requirements. The connection through the PCU 208, the SGSN 216 and the GGSN 218 to a public or private network (Internet) 224 (also referred to herein generally as a shared network infrastructure) represents the data path for GPRS capable mobile devices. In a GSM network extended with GPRS capabilities, the BSC 204 also contains the Packet Control Unit (PCU) 208 that connects to the SGSN 216 to control segmentation, radio channel allocation and to satisfy packet switched requirements. To track the location of the mobile device 100 and availability for both circuit switched and packet switched management, the HLR 212 is shared between the MSC 210 and the SGSN 216. Access to the VLR 214 is controlled by the MSC 210.

The station 206 is a fixed transceiver station and together with the BSC 204 form fixed transceiver equipment. The fixed transceiver equipment provides wireless network coverage for a particular coverage area commonly referred to as a “cell”. The fixed transceiver equipment transmits communication signals to and receives communication signals from mobile devices within its cell via the station 206. The fixed transceiver equipment normally performs such functions as modulation and possibly encoding and/or encryption of signals to be transmitted to the mobile device 100 in accordance with particular, usually predetermined, communication protocols and parameters, under control of its controller. The fixed transceiver equipment similarly demodulates and possibly decodes and decrypts, if necessary, any communication signals received from the mobile device 100 within its cell. Communication protocols and parameters may vary between different nodes. For example, one node may employ a different modulation scheme and operate at different frequencies than other nodes.

For all mobile devices 100 registered with a specific network, permanent configuration data such as a user profile is stored in the HLR 212. The HLR 212 also contains location information for each registered mobile device and can be queried to determine the current location of a mobile device. The MSC 210 is responsible for a group of location areas and stores the data of the mobile devices currently in its area of responsibility in the VLR 214. Further, the VLR 214 also contains information on mobile devices that are visiting other networks. The information in the VLR 214 includes part of the permanent mobile device data transmitted from the HLR 212 to the VLR 214 for faster access. By moving additional information from a remote HLR 212 node to the VLR 214, the amount of traffic between these nodes can be reduced so that voice and data services can be provided with faster response times and at the same time requiring less use of computing resources.

The SGSN 216 and the GGSN 218 are elements added for GPRS support; namely packet switched data support, within GSM. The SGSN 216 and the MSC 210 have similar responsibilities within the wireless network 200 by keeping track of the location of each mobile device 100. The SGSN 216 also performs security functions and access control for data traffic on the wireless network 200. The GGSN 218 provides internetworking connections with external packet switched networks and connects to one or more SGSN's 216 via an Internet Protocol (IP) backbone network operated within the network 200. During normal operations, a given mobile device 100 must perform a “GPRS Attach” to acquire an IP address and to access data services. This requirement is not present in circuit switched voice channels as Integrated Services Digital Network (ISDN) addresses are used for routing incoming and outgoing calls. Currently, all GPRS capable networks use private, dynamically assigned IP addresses, thus requiring the DHCP server 220 connected to the GGSN 218. There are many mechanisms for dynamic IP assignment, including using a combination of a Remote Authentication Dial-In User Service (RADIUS) server and a DHCP server. Once the GPRS Attach is complete, a logical connection is established from a mobile device 100, through the PCU 208, and the SGSN 216 to an Access Point Node (APN) within the GGSN 218. The APN represents a logical end of an IP tunnel that can either access direct Internet compatible services or private network connections. The APN also represents a security mechanism for the network 200, insofar as each mobile device 100 must be assigned to one or more APNs and mobile devices 100 cannot exchange data without first performing a GPRS Attach to an APN that it has been authorized to use. The APN may be considered to be similar to an Internet domain name such as “myconnection.wireless.com”.

Once the GPRS Attach operation is complete, a tunnel is created and all traffic is exchanged within standard IP packets using any protocol that can be supported in IP packets. This includes tunneling methods such as IP over IP as in the case with some IPSecurity (IPsec) connections used with Virtual Private Networks (VPN). These tunnels are also referred to as Packet Data Protocol (PDP) Contexts and there are a limited number of these available in the network 200. To maximize use of the PDP Contexts, the network 200 will run an idle timer for each PDP Context to determine if there is a lack of activity. When a mobile device 100 is not using its PDP Context, the PDP Context can be de-allocated and the IP address returned to the IP address pool managed by the DHCP server 220.

Referring now to FIG. 4, shown therein is a block diagram illustrating components of an example configuration of a host system 250 that the mobile device 100 can communicate with in conjunction with the connect module 144. The host system 250 will typically be a corporate enterprise or other local area network (LAN), but may also be a home office computer or some other private system, for example, in variant implementations. In this example shown in FIG. 4, the host system 250 is depicted as a LAN of an organization to which a user of the mobile device 100 belongs. Typically, a plurality of mobile devices can communicate wirelessly with the host system 250 through one or more nodes 202 of the wireless network 200.

The host system 250 comprises a number of network components connected to each other by a network 260. For instance, a user's desktop computer 262a with an accompanying cradle 264 for the user's mobile device 100 is situated on a LAN connection. The cradle 264 for the mobile device 100 can be coupled to the computer 262a by a serial or a Universal Serial Bus (USB) connection, for example. Other user computers 262b-262n are also situated on the network 260, and each may or may not be equipped with an accompanying cradle 264. The cradle 264 facilitates the loading of information (e.g. PIM data, private symmetric encryption keys to facilitate secure communications) from the user computer 262a to the mobile device 100, and may be particularly useful for bulk information updates often performed in initializing the mobile device 100 for use. The information downloaded to the mobile device 100 may include certificates used in the exchange of messages.

It will be understood by persons skilled in the art that the user computers 262a-262n will typically also be connected to other peripheral devices, such as printers, etc. which are not explicitly shown in FIG. 4. Furthermore, only a subset of network components of the host system 250 are shown in FIG. 4 for ease of exposition, and it will be understood by persons skilled in the art that the host system 250 will comprise additional components that are not explicitly shown in FIG. 4 for this example configuration. More generally, the host system 250 may represent a smaller part of a larger network (not shown) of the organization, and may comprise different components and/or be arranged in different topologies than that shown in the example embodiment of FIG. 4.

To facilitate the operation of the mobile device 100 and the wireless communication of messages and message-related data between the mobile device 100 and components of the host system 250, a number of wireless communication support components 270 can be provided. In some implementations, the wireless communication support components 270 can include a message management server 272, a mobile data server 274, a contact server 276, and a device manager module 278. The device manager module 278 includes an IT Policy editor 280 and an IT user property editor 282, as well as other software components for allowing an IT administrator to configure the mobile devices 100. In an alternative example embodiment, there may be one editor that provides the functionality of both the IT policy editor 280 and the IT user property editor 282. The support components 270 also include a data store 284, and an IT policy server 286. The IT policy server 286 includes a processor 288, a network interface 290 and a memory unit 292. The processor 288 controls the operation of the IT policy server 286 and executes functions related to the standardized IT policy as described below. The network interface 290 allows the IT policy server 286 to communicate with the various components of the host system 250 and the mobile devices 100. The memory unit 292 can store functions used in implementing the IT policy as well as related data. Those skilled in the art know how to implement these various components. Other components may also be included as is well known to those skilled in the art. Further, in some implementations, the data store 284 can be part of any one of the servers.

In this example embodiment, the mobile device 100 communicates with the host system 250 through node 202 of the wireless network 200 and a shared network infrastructure 224 such as a service provider network or the public Internet. Access to the host system 250 may be provided through one or more routers (not shown), and computing devices of the host system 250 may operate from behind a firewall or proxy server 266. The proxy server 266 provides a secure node and a wireless internet gateway for the host system 250. The proxy server 266 intelligently routes data to the correct destination server within the host system 250.

In some implementations, the host system 250 can include a wireless VPN router (not shown) to facilitate data exchange between the host system 250 and the mobile device 100. The wireless VPN router allows a VPN connection to be established directly through a specific wireless network to the mobile device 100. The wireless VPN router can be used with the Internet Protocol (IP) Version 6 (IPV6) and IP-based wireless networks. This protocol can provide enough IP addresses so that each mobile device has a dedicated IP address, making it possible to push information to a mobile device at any time. An advantage of using a wireless VPN router is that it can be an off-the-shelf VPN component, and does not require a separate wireless gateway and separate wireless infrastructure. A VPN connection can preferably be a Transmission Control Protocol (TCP)/IP or User Datagram Protocol (UDP)/IP connection for delivering the messages directly to the mobile device 100 in this alternative implementation.

Messages intended for a user of the mobile device 100 are initially received by a message server 268 of the host system 250. Such messages may originate from any number of sources. For instance, a message may have been sent by a sender from the computer 262b within the host system 250, from a different mobile device (not shown) connected to the wireless network 200 or a different wireless network, or from a different computing device, or other device capable of sending messages, via the shared network infrastructure 224, possibly through an application service provider (ASP) or Internet service provider (ISP), for example.

The message server 268 typically acts as the primary interface for the exchange of messages, particularly e-mail messages, within the organization and over the shared network infrastructure 224. Each user in the organization that has been set up to send and receive messages is typically associated with a user account managed by the message server 268. Some example implementations of the message server 268 include a Microsoft Exchange™ server, a Lotus Domino™ server, a Novell Groupwise™ server, or another suitable mail server installed in a corporate environment. In some implementations, the host system 250 may comprise multiple message servers 268. The message server 268 may also be adapted to provide additional functions beyond message management, including the management of data associated with calendars and task lists, for example.

When messages are received by the message server 268, they are typically stored in a data store associated with the message server 268. In at least some example embodiments, the data store may be a separate hardware unit, such as data store 284, that the message server 268 communicates with. Messages can be subsequently retrieved and delivered to users by accessing the message server 268. For instance, an e-mail client application operating on a user's computer 262a may request the e-mail messages associated with that user's account stored on the data store associated with the message server 268. These messages are then retrieved from the data store and stored locally on the computer 262a. The data store associated with the message server 268 can store copies of each message that is locally stored on the mobile device 100. Alternatively, the data store associated with the message server 268 can store all of the messages for the user of the mobile device 100 and only a smaller number of messages can be stored on the mobile device 100 to conserve memory. For instance, the most recent messages (i.e. those received in the past two to three months for example) can be stored on the mobile device 100.

When operating the mobile device 100, the user may wish to have e-mail messages retrieved for delivery to the mobile device 100. The message application 138 operating on the mobile device 100 may also request messages associated with the user's account from the message server 268. The message application 138 may be configured (either by the user or by an administrator, possibly in accordance with an organization's information technology (IT) policy) to make this request at the direction of the user, at some pre-defined time interval, or upon the occurrence of some pre-defined event. In some implementations, the mobile device 100 is assigned its own e-mail address, and messages addressed specifically to the mobile device 100 are automatically redirected to the mobile device 100 as they are received by the message server 268.

The message management server 272 can be used to specifically provide support for the management of messages, such as e-mail messages, that are to be handled by mobile devices. Generally, while messages are still stored on the message server 268, the message management server 272 can be used to control when, if, and how messages are sent to the mobile device 100. The message management server 272 also facilitates the handling of messages composed on the mobile device 100, which are sent to the message server 268 for subsequent delivery.

For example, the message management server 272 may monitor the user's “mailbox” (e.g. the message store associated with the user's account on the message server 268) for new e-mail messages, and apply user-definable filters to new messages to determine if and how the messages are relayed to the user's mobile device 100. The message management server 272 may also compress and encrypt new messages (e.g. using an encryption technique such as Data Encryption Standard (DES), Triple DES, or Advanced Encryption Standard (AES)) and push them to the mobile device 100 via the shared network infrastructure 224 and the wireless network 200. The message management server 272 may also receive messages composed on the mobile device 100 (e.g. encrypted using Triple DES), decrypt and decompress the composed messages, re-format the composed messages if desired so that they will appear to have originated from the user's computer 262a, and re-route the composed messages to the message server 268 for delivery.

Certain properties or restrictions associated with messages that are to be sent from and/or received by the mobile device 100 can be defined (e.g. by an administrator in accordance with IT policy) and enforced by the message management server 272. These may include whether the mobile device 100 may receive encrypted and/or signed messages, minimum encryption key sizes, whether outgoing messages must be encrypted and/or signed, and whether copies of all secure messages sent from the mobile device 100 are to be sent to a pre-defined copy address, for example.

The message management server 272 may also be adapted to provide other control functions, such as only pushing certain message information or pre-defined portions (e.g. “blocks”) of a message stored on the message server 268 to the mobile device 100. For example, in some cases, when a message is initially retrieved by the mobile device 100 from the message server 268, the message management server 272 may push only the first part of a message to the mobile device 100, with the part being of a pre-defined size (e.g. 2 KB). The user can then request that more of the message be delivered in similar-sized blocks by the message management server 272 to the mobile device 100, possibly up to a maximum pre-defined message size. Accordingly, the message management server 272 facilitates better control over the type of data and the amount of data that is communicated to the mobile device 100, and can help to minimize potential waste of bandwidth or other resources.

The mobile data server 274 encompasses any other server that stores information that is relevant to the corporation. The mobile data server 274 may include, but is not limited to, databases, online data document repositories, customer relationship management (CRM) systems, or enterprise resource planning (ERP) applications.

The contact server 276 can provide information for a list of contacts for the user in a similar fashion as the address book on the mobile device 100. Accordingly, for a given contact, the contact server 276 can include the name, phone number, work address and e-mail address of the contact, among other information. The contact server 276 can also provide a global address list that contains the contact information for all of the contacts associated with the host system 250.

It will be understood by persons skilled in the art that the message management server 272, the mobile data server 274, the contact server 276, the device manager module 278, the data store 284 and the IT policy server 286 do not need to be implemented on separate physical servers within the host system 250. For example, some or all of the functions associated with the message management server 272 may be integrated with the message server 268, or some other server in the host system 250. Alternatively, the host system 250 may comprise multiple message management servers 272, particularly in variant implementations where a large number of mobile devices need to be supported.

Alternatively, in some example embodiments, the IT policy server 286 can provide the IT policy editor 280, the IT user property editor 282 and the data store 284. In some cases, the IT policy server 286 can also provide the device manager module 278. The processor 288 of the IT policy server 286 can be used to perform the various steps of a method for providing IT policy data that is customizable on a per-user basis. The processor 288 can execute the editors 280 and 282. In some cases, the functionality of the editors 280 and 282 can be provided by a single editor. In some cases, the memory unit 292 can provide the data store 284.

The device manager module 278 provides an IT administrator with a graphical user interface with which the IT administrator interacts to configure various settings for the mobile devices 100. As mentioned, the IT administrator can use IT policy rules to define behaviors of certain applications on the mobile device 100 that are permitted such as phone, web browser or Instant Messenger use. The IT policy rules can also be used to set specific values for configuration settings that an organization requires on the mobile devices 100 such as auto signature text, WLAN/VoIP/VPN configuration, security requirements (e.g. encryption algorithms, password rules, etc.), specifying themes or applications that are allowed to run on the mobile device 100, and the like.

Although in the foregoing example embodiment the mobile device 100 is described as being in direct communication with the wireless network 200, this may not be the case in alternative embodiments. For example, FIG. 4 also depicts the mobile device 100 being connected to the wireless network 200 via another mobile device 100a (“hotspot mobile device”). The hotspot mobile device 100a is directly connected to the wireless network and acts as a wireless hotspot to which the mobile device 100 can connect and through which the mobile device 100 can access the wireless network 200. For example, the wireless network 200 may be the Internet, the hotspot mobile device 100a may be a smart-phone that connects to the Internet using WiFi 802.11 or a 3G cellular network, and the mobile device 100 may communicate with the smart-phone using Bluetooth. The mobile device 100 that is connected to the smart-phone may be another smart-phone or a tablet computer, for example.

Increasingly, users are editing files on their mobile devices 100. These files can include documents, spreadsheets, and images. While using the mobile device 100 to edit a file can facilitate portability and productivity, doing so also highlights a number of technical problems. Some of these technical problems are related to saving the file being edited.

For example, when the file that is being edited on the mobile device 100 is saved, the file often is not saved locally to the mobile device 100 but is instead transmitted from the mobile device 100 and saved remotely. The file may be transmitted over the wireless network 200 to be saved on a storage device such as a web server (not shown). Additionally or alternatively, when the mobile device 100 is connected to the wireless network 200 via the hotspot mobile device 100a, the file may be stored on the hotspot mobile device 100a. The mobile device 100 may store the file on to the hotspot mobile device 100a even when the hotspot mobile device 100a is not connected to the wireless network 200. For example, the file may be stored on the hotspot mobile device 100a in expectation that future connectivity to the wireless network 200 will be restored, at which point the saved file can be transmitted over the wireless network 200.

One technical problem associated with saving the file remotely is battery drainage. Each time the file is saved, the mobile device 100 transmits the file. When the mobile device 100 is communicating wirelessly, saving involves wirelessly sending the file using the communication subsystem 104; doing so utilizes a significant amount of battery power. Consequently, saving the file frequently comes at the cost of noticeably decreased battery life.

Another technical problem associated with saving the file remotely is bandwidth costs. When the file is transmitted from the mobile device 100 to the wireless network 200 for remote saving, the user will often be charged for making that transmission. Consequently, saving the file frequently can also result in increased user fees.

A third technical problem associated with saving the file remotely is allocation of limited processing power. Each time the file is saved, the main processor 102 executes save-related algorithms and transmits the file using the communication subsystem 104. Doing so consumes resources that could otherwise be used to operate a user interface. Consequently, frequently saving the file may introduce a perceptible and undesirable lag to the user interface.

Although technical problems can make frequently saving the file problematic (especially when the file is saved remotely), frequent saving has the advantage of storing the file such that if the software being used to edit the file or the mobile device 100 crash, or if the connection to the wireless network 200 is lost, a recent version of the file will have been saved and will be accessible at a later time. Frequent saving is a desirable enough feature that many pieces of software include an “autosave” feature by which the file is periodically saved automatically without any explicit user prompting.

The following embodiments are accordingly directed at a method and system for automatically saving a file. Instead of autosaving based only on how much time has passed since the last save or constantly autosaving after every keystroke, the following embodiments disclose a method and system for autosaving that considers one or both of the nature of the changes made to the file and the operating environment in which the file is being edited, and that automatically saves the file more frequently when the changes imply that the file has been materially changed or when the file is being edited in an unstable or hostile environment. The following embodiments therefore facilitate timely autosaving of the file so as to capture material changes made to the file, but alleviates the problems associated with inefficient or untimely use of battery, bandwidth, and processing resources.

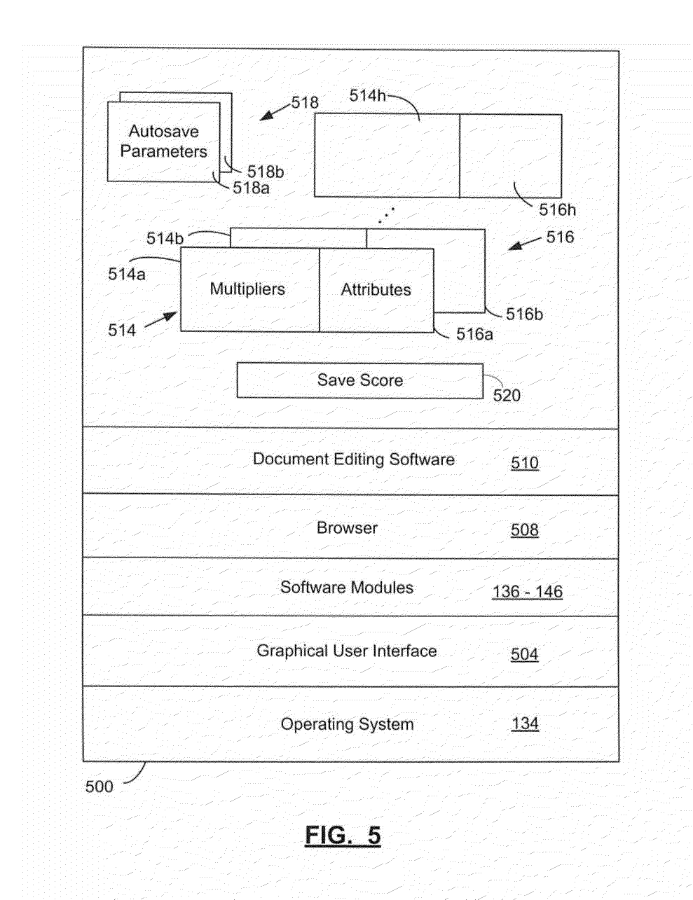

Referring now to FIG. 5, there are depicted selected modules of a memory 500 of the mobile device 100 of FIG. 1, according to a first example embodiment. The memory may be representative of the flash memory 108, the RAM 106, other memories of the mobile device 100 such as those accessible through or acting as the other device subsystems 124, or a combination of any of the foregoing. In the first example embodiment, the file being edited is a document that contains text, but in alternative embodiments the file may be a spreadsheet or an image, for example. Resident in the memory 500 is the operating system 134 that presents to the user a graphical user interface (GUI) 504. The GUI 504 may, for example, obtain user input from any one or more of the auxiliary I/O subsystem 112, the keyboard 116 and the microphone 120, and present output to the user primarily through the display 110. The GUI 504 is typically a component of the operating system 134.

The software modules 136 to 146 are also resident in the memory 500. The memory 500 can include a browser 508 for browsing the Internet. The browser 508 can be used to access a document editing website that allows documents to be edited locally on the mobile device 100, but that saves documents remotely on a web server that the mobile device 100 accesses wirelessly through the wireless network 200. Alternatively, instead of editing documents using the document editing website, document editing software 510 resident locally on the mobile device 100 in the memory 500 can be used. Notwithstanding that the document editing software 510 is resident locally on the mobile device 100, the document being edited may still be saved remotely from the mobile device 100, such as on the web server or on the hotspot mobile device 100a. Additionally or alternatively, the document or other file being edited may be automatically locally saved in the memory 500.

Regardless of what type of software is being used to edit the document, various blocks and types of data that the main processor 102 accesses and uses when determining whether to autosave the document are also stored in the memory 500. In the first example embodiment, the main processor 102 determines a save score 520 when determining whether to autosave the document. When the save score 520 exceeds a save threshold, the document is autosaved; the document is otherwise not autosaved. To determine the save score 520, the main processor 102 determines autosave indicators by multiplying together a multiplier 514a-h (collectively 514) and a document or operating environment attribute 516a-h (hereinafter simply referred to as an “attribute”, and collectively 516), and by using the resulting autosave indicators to modify the save score 520. Each of the attributes 516, and consequently each of the autosave indicators, represents an attribute of one or both of the document and the environment in which the document is being edited that is indicative of whether it would be appropriate or beneficial to immediately autosave the document.

Many different types of attributes 516 can be used in determining whether to autosave the document. A non-exhaustive description of the attributes 516 used in the first example embodiment follows.

One example attribute 516a is the number of characters typed since the document was last saved (“dirty character attribute”). The greater the number of dirty characters, the more reason there is to autosave the document as the number of dirty characters represents the unsaved changes present in the document.

A second example attribute 516b is the time that has elapsed since the document was last saved (“time since last save attribute”). The greater the time that has elapsed, the more reason there is to autosave the document because if unsaved changes are lost there is a greater likelihood that the author will not be able to remember what changes were made if they were made a substantial time in the past.

A third example attribute 516c is the size of the document (“document size attribute”). The larger the size of the document, the less significant each marginal change made to the document is in terms of the percentage of the document that has been changed. Furthermore, saving a relatively large document consumes more bandwidth, processor, and battery resources than saving a relatively small document. Consequently, having a large document size tends to reduce the frequency at which the document is autosaved.

A fourth example attribute 516d is whether the document is in the foreground or the background of the user interface (“foreground attribute”). If the document is saved while it is in the foreground, there may be a higher likelihood that the user will notice a decrease in responsiveness of the GUI as a result of the main processor 102 having to attend to the save. Consequently, it may be worthwhile to save less frequently when the document is in the foreground of the user interface, especially if some of the other attributes 516 are relied upon to cause the document to be autosaved when the document is edited while in the foreground.

A fifth example attribute 516e is the type of file that is being edited (“file type attribute”). For example, it may be more difficult to reproduce changes made to an image that are lost as opposed to changes made to a document. Consequently, this attribute 516e may be higher for images than documents. A numeric value, which depends on the file type, can be selected as the file type attribute 516e. For example, the file type attribute 516e may be “1” for a text document, and “3” for an image.

A sixth example attribute 516f is typing speed (“typing speed attribute”). Typing speed refers to the number of characters typed in the document in a certain period of time (e.g. the previous 30 seconds). The higher the typing speed, the more likely it is that processing resources are being used to interact with the user via the GUI and to process incoming data, and the higher the likelihood that an autosave will cause a noticeable lag in the GUI. Consequently, the higher the typing speed attribute 516f, the lower the incentive to autosave the document.

A seventh example attribute 516g is the number of return characters added to the document since the last save (“return characters attribute”). The greater the number of return characters, the more likely that paragraphs have been completed, which often represent the completion of a material change to a document. Consequently, as the number of return characters increases, the importance of autosaving the document increases.

An eighth example attribute 516h is the age of the document (“document age attribute”). As the document ages, it may be more likely that incremental, relatively minor changes will be made to the document as opposed to changes that substantially alter the scope and spirit of the document. Consequently, as the document ages, the importance of autosaving the document decreases.

While the first example embodiment utilizes the foregoing eight attributes 516a-h, in alternative embodiments not all of these attributes a-h are used. Furthermore, in alternative embodiments different attributes that are not mentioned above may be used. For example, in an alternative embodiment the amount of time that has passed since the last keystroke may be used as an attribute. If the time since the last keystroke has surpassed a certain period of time (e.g. 15 seconds), the likelihood that the user is away from the document or is taking a break from working on the document may increase, and it may be an opportune time to save the document because any lag introduced to the GUI by saving the document may consequently not be noticed by the user. Also in alternative embodiments, some of the same attributes 516 discussed above may be used in a different way. For example, in an alternative embodiment directed at a series of old documents that are all being revised to incorporate particular changes, the document age attribute 516h may be modified such that the very old documents are autosaved frequently.

The multiplier 514a-h associated with each of the attributes 516a-h assigns a specific weight to its respective attribute 516a-h depending on the attribute's 516a-h importance in determining whether or not to perform an autosave. For example, the save threshold may be “100” and the autosave indicator may adjust the save score 520 by being added to the save score 520. In this case, if the attribute 516a is the number of dirty characters in the document, the user may assign the multiplier 514a a value of 25 if the user wants to the document to be autosaved at least approximately every four dirty characters. In some example embodiments, one or more of the attributes 516 may optionally be real-time data, such as the number of seconds the document has been open. For ease of reference, the indicator that results from multiplying the dirty character attribute 516a by its respective multiplier 514a is referred to as the “dirty character indicator”, the indicator that results from multiplying the time since last save attribute 516b by its respective multiplier 514b is referred to as the “time since last save indicator”, and the remaining indicators are analogously named.

Also residing in the memory 500 are a number of autosave parameters 518a,b (collectively 518) that the main processor 102 uses in determining when to perform an autosave. In the first example embodiment, one of the autosave parameters 518a is the save threshold against which the save score 520 is compared. The other of the autosave parameters 518b is a timeout period following the expiry of which the main processor 102 checks to see whether the document should be autosaved. The autosave parameters 518 may be constants selected by a software programmer, or alternatively may be user adjustable. For example, the user may be prompted through the GUI to specify what the save threshold is so as to control the frequency of autosaves.

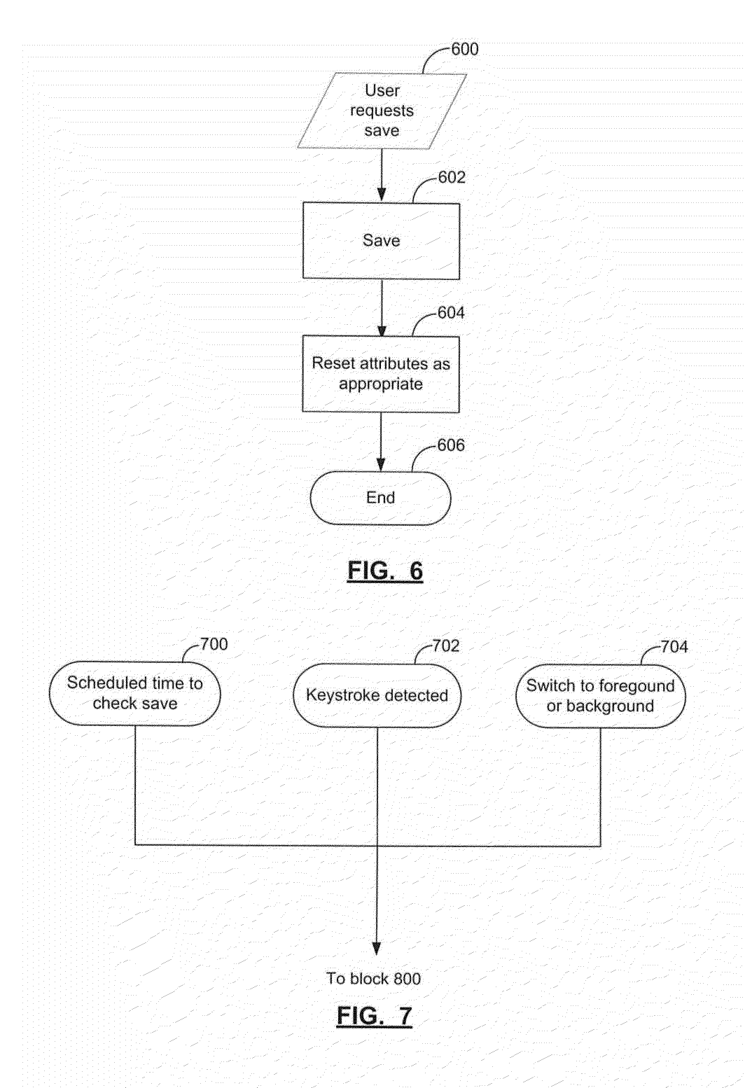

The instructions that the main processor 102 executes in determining whether to perform an autosave may form part of the document editing software 510, part of the browser 508 in the form of a browser plug-in, or may reside elsewhere in the memory 500. FIGS. 6 to 9 depict example methods that the main processor 102 performs, in accordance with the first example embodiment.

Referring now to FIG. 6, there is depicted a flowchart indicating an example method that the main processor 102 executes when the user expressly requests that the document be saved. This can occur, for example, when the user clicks a “save” icon that is displayed using the GUI or when the user inputs a “save” command using the keyboard 116. At block 600, the user actively requests that the document be saved. In response to this, the main processor 102 saves the document at block 602. Following the save, the main processor 102 at 604 resets the dirty characters attribute 516a, the time since last save attribute 516b, and the return characters attribute 516h to zero, and the method ends at block 606.

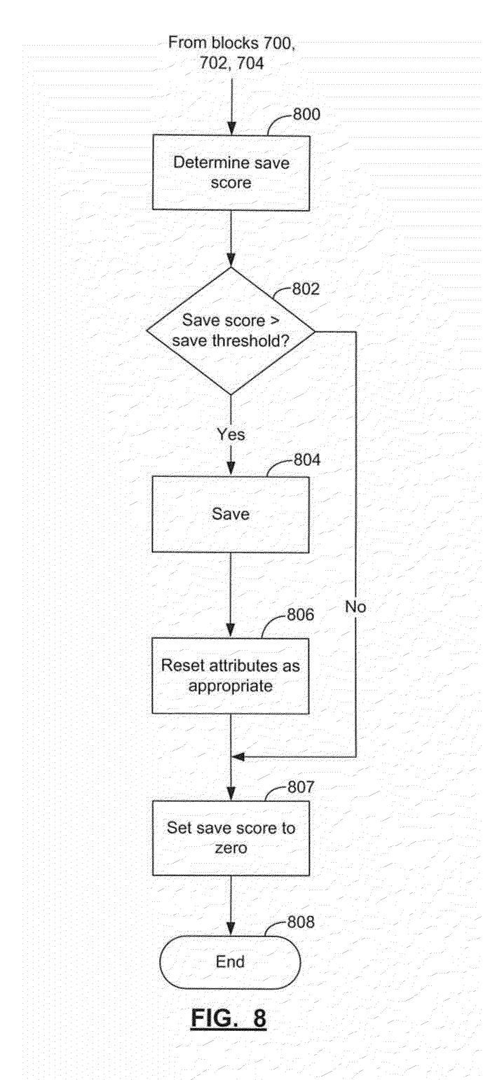

Referring now to FIG. 7, there is depicted a flowchart that shows the example triggers that initiate performance of an example method for automatically saving a file, according to the first example embodiment. In FIG. 7, three example triggers are depicted, each of which trigger an interrupt within the mobile device 100 to which the main processor 102 reacts. Following triggering of the interrupt, the main processor proceeds to block 800 of FIG. 8, which depicts the example method for automatically saving a file.

The main processor 102 proceeds to block 700 when a timer (not shown), which is set to count down the timeout period stored as the autosave parameter 518b, expires. The main processor 102 resets the timer once it expires; the timer consequently expires periodically with a period of the timeout period. In this way, the main processor 102 will perform the method depicted in FIG. 8 at least every timeout period. The main processor 102 proceeds to block 702 every time the document is altered using the keyboard 116. In this way, the main processor 102 will perform the method of FIG. 8 every time a dirty character is added to the document. Similarly, the main processor 102 proceeds to block 704 and performs the method of FIG. 8 every time the document is switched between the foreground and background of the user interface. In an alternative embodiment (not depicted), the main processor 102 may be configured to additionally or alternatively perform the method of FIG. 8 in response to other triggers. Examples of these alternative triggers include any one or more of detection of a threshold number of keystrokes as opposed to every keystroke; detection that the document has exceeded a certain age; detection that average typing speed over a certain period of time has exceeded a certain threshold; and any suitable type of trigger related to any of the attributes 516a-h.

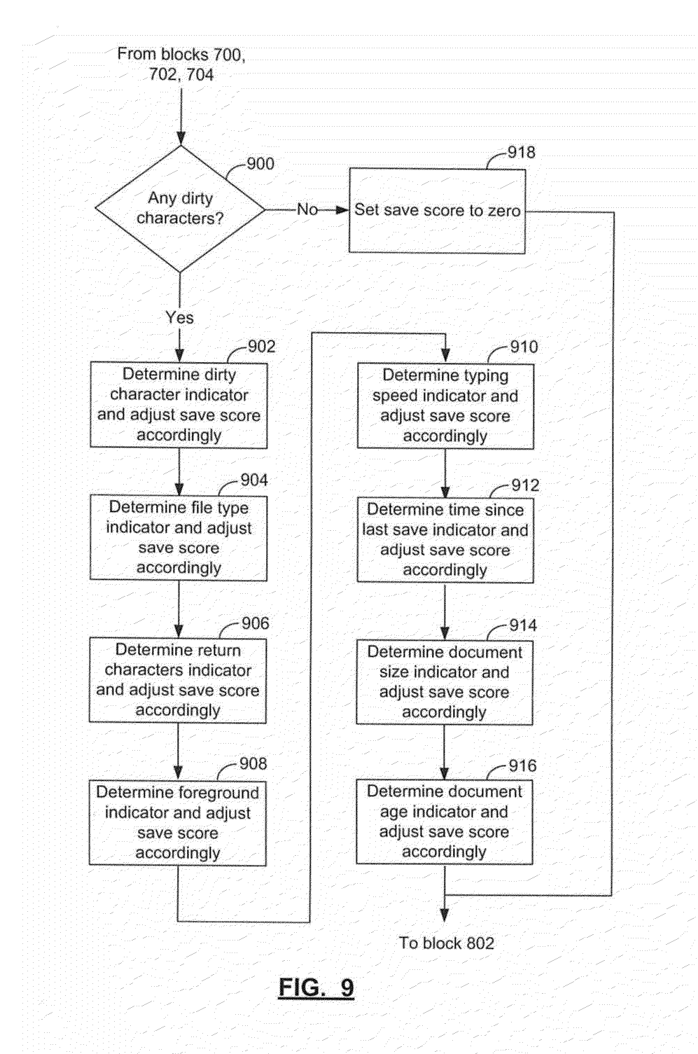

Referring now to FIG. 8, there is shown the example method for automatically saving a file. After any of the interrupts of FIG. 7 are triggered, the main processor determines the save score 520 at block 800. An example method by which the main processor can determine the save score 520 is depicted in FIG. 9, and discussed in more detail below. Following determination of the save score 520, the save score is compared to the save threshold at block 802. The save threshold may be user configured such that the user can determine how frequently autosaves occur; alternatively, the save threshold may be a constant that the user cannot alter. If the save score 520 exceeds the save threshold, the main processor 102 saves the document at 804 and at 806 resets the dirty characters attribute 516a, the time since last save attribute 516b, and the return characters attribute 516h. The method then resets the save score 520 to zero at block 807, and ends at block 808. If the save score 520 does not exceed the save threshold, the document is not saved and blocks 804 and 806 are accordingly bypassed, and the main processor 102 directly proceeds to blocks 807 and 808.

Referring now to FIG. 9, there is shown a flowchart of an example method for determining the save score 520. After any of the interrupts of FIG. 7 are triggered, the main processor 102 determines whether there are any conditions satisfied that will render moot all of the autosave indicators represented in blocks 902 to 916. For example, in block 900 the main processor 102 immediately determines whether any dirty characters are present in the file at all; if not, no changes have been made to the document, and saving will have no beneficial effect. Consequently, the save score is set to zero at block 918, and the main processor returns to block 802 where, assuming the save threshold is positive, no autosave will occur. In an example embodiment in which the mobile device 100 is connected to the wireless network 200 via the hotspot mobile device 100a and the document is being saved on the hotspot mobile device 100a, another condition that can prevent an autosave from occurring is when the network connection between the hotspot mobile device 100a and the mobile device 100 is lost.

If at block 900 the main processor determines that dirty characters are present in the file, the file has been changed since the last time the file was saved and the main processor 102 will proceed to block 902. As discussed in greater detail below, at blocks 902 to 916 the main processor 102 determines the autosave indicators and uses them to adjust the save score 520. At block 902 the main processor 102 determines the dirty character indicator and adjusts the save score 520 accordingly. At block 904 the main processor 102 determines the file type indicator and adjusts the save score 520 accordingly. At block 906 the main processor 102 determines the return characters indicator and adjusts the save score 520 accordingly. At block 908 the main processor 102 determines the foreground indicator and adjusts the save score 520 accordingly. At block 910 the main processor 102 determines the typing speed indicator and adjusts the save score 520 accordingly. At block 912 the main processor 102 determines the time since last save indicator and adjusts the save score 520 accordingly. At block 914 the main processor 102 determines the document size indicator and adjusts the save score 520 accordingly. And, at block 916, the main processor 102 determines the document age indicator and adjusts the save score 520 accordingly. Following block 916, the main processor 102 proceeds to block 802 to compare the save score 520 to the save threshold. If the save score 520 exceeds the save threshold, then the main processor 102 saves the document; otherwise, the main processor 102 does not save the document.

As illustrated in the following examples, the autosave indicators may be positive or negative. In the first example embodiment, the save threshold is positive; however, in alternative embodiments the threshold may be negative or zero. In the first example embodiment, for autosave indicators that adjust the save score 520 by being added to or subtracted from the save score 520, when the product of the multiplier 514 and its respective attribute 516 is positive and the save score 520 is increased, the likelihood that an autosave will occur is increased; when the product is negative and the save score 520 is decreased, the likelihood that an autosave will occur is decreased. Similarly, when the save score 520 is positive and for autosave indicators that adjust the save score 520 by scaling the save score 520, when the product of the multiplier 514 and its respective attribute 516 is greater than one the save score 520 and the likelihood that an autosave will occur are increased; when the product is between zero and one, the save score 520 and the likelihood that an autosave will occur are decreased. In the first example embodiment, the autosave indicators that adjust the save score 520 by scaling the save score 520 are positive, but this may be different in alternative embodiments. A particular one of the autosave indicators is considered to “adjust” the save score 520 if it changes the value of the save score 520. For example, in the first example embodiment, if the autosave indicators that are added to or subtracted from the save score 520 are zero, they do not adjust the save score 520 because they do not alter the value of the save score 520. Similarly, if the autosave indicators that scale the save score 520 equal one, they do not adjust the save score 520 because they do not alter the value of the save score 520.

Each of the autosave indicators is determined by multiplying together each of the multipliers 514a-h by its related attribute 516a-h. For example, the dirty character indicator is determined by multiplying the dirty character multiplier 514a by the dirty character attribute 516a. Each of the dirty character indicator, file type indicator, and return characters indicator is determined using a positive multiplier 514 and is positive. The typing speed indicator and the foreground indicator are determined using a negative multiplier 514 and are negative. Following their determination, each of these indicators are used to adjust the save score 520 by being added to it. Consequently, at blocks 902 to 906 the dirty character, file type, and return characters indicators increment the save score 520, while at blocks 908 and 910 the foreground indicator and the typing speed indicator decrement the save score 520. In the first example embodiment, the save score 520 is kept non-negative by decrementing the save score 520 to, but not below, zero, regardless of the magnitude of the foreground and typing speed indicators. However, in alternative embodiments, the save score 520 can be allowed to become negative.

The time since last save indicator is greater than one and is determined using a positive multiplier 514. The time since last save indicator is used to adjust the save score 520 by scaling it. In other words, at block 912 the save score 520 and the time since last save indicator are multiplied together, and, assuming the save score 520 is positive, the time since last save indicator increases the save score 520 and the likelihood that an autosave will occur.

The document size indicator adjusts the save score 520 by scaling it, and is determined using a positive multiplier 514 such that when the document size multiplier 514c is multiplied by the document size attribute 516c, the resulting document size indicator is between zero and one. Because the document size indicator is between zero and one, assuming the save score 520 is positive the document size indicator has the effect of decreasing the likelihood of an autosave. The main processor 102 determines the document size indicator and uses it to scale the save score 520 at block 914.

The document age indicator is determined using a positive multiplier 514. The document age attribute 516h asymptotically approaches the inverse of the document age multiplier 514h as the age of the document approaches infinity; consequently, the document age indicator continuously decreases and approaches one as the document age approaches infinity. As with the time since last save indicator, at block 916 the document age indicator is determined and the save score 520 and the document age indicator are multiplied together. Assuming the save score 520 is positive, the document age indicator increases the save score 520 and the likelihood of an autosave occurring.

Following block 916, the main processor 102 proceeds to block 802 at which the save score 520 is compared to the save threshold and an autosave accordingly is or is not performed, as described above.

An example of the first example embodiment in operation involves autosaving the document based on the number of dirty characters in the document, the typing speed of the document, and the time since the document was last saved. Accordingly, only the dirty character attribute 516a and multiplier 514a, the typing speed attribute 516f and multiplier 514f, and the time since last save attribute 516b and multiplier 514b affect the save score 520; in order to eliminate the effect of the remaining attributes 516, their respective multipliers 514 are set to zero. The save score 520 is also initialized to zero. In this example, the save threshold is set to “100”; the dirty character multiplier 514a is set to (8/characters); the typing speed multiplier 514f is set to (−1 minute/4 words), and the typing speed attribute 516f is calculated over the previous one minute; and the time since last save multiplier 514b is set to (7/minutes).

In this example, the user has edited the document via the keyboard and the main processor 102 accordingly proceeds to block 702. The number of dirty characters since the last save is 14 characters; the typing speed as calculated over the past one minute is 85 words per minute; and the last save was performed 10 seconds ago. From block 702 the main processor proceeds to block 800, and then to block 900 of FIG. 9. In FIG. 9, only blocks 902, 910 and 912 factor into determining the save score 520. At block 902, the dirty character indicator equals (14 characters)*(8/characters)=112, and the save score 520 is incremented from zero to 112. At block 910, the typing speed indicator equals (85 words/minute)*(−1 minute/4 words)=−21.25, and the save score 520 is decremented to 90.75. At block 912, the time since last save indicator equals (10 seconds)*(7/minutes)=1.17, and the save score 520 of 91.25 is scaled by 1.17 to the final save score 520 of 106. The main processor 102 then proceeds to block 802 and, determining that the save score 520 exceeds the save threshold, automatically saves the document. The dirty characters attribute 516a and time since last save attribute 516b are reset to zero at block 806, the save score 520 is reset to zero at block 807, and the method ends at block 808.

This example is one in which notwithstanding a very recent save made 10 seconds in the past and the fact that the typing speed is relatively high, the number of dirty characters is high enough that another autosave is nonetheless performed. This is an example of beneficially combining multiple autosave parameters to determine whether to automatically save the document, as opposed to simply relying on a single autosave indicator.

In the foregoing example, the number of dirty characters justifies utilizing the system resources to autosave the document. In another example in which system resources may be more valuable, the time since last save multiplier 514b may be set to (5/minutes); in this example, the save score 520 would be 75.6, and the main processor 102 would not automatically save the document. This example illustrates how changing the multipliers 514 allows the relative importance of the attributes 516 to be configured on a case-by-case basis, if desired.

In another example, even if the time since last save multiplier 514b remains (7/minutes), the number of dirty characters may be 12 characters instead of 14; in this example, the save score 520 is set to 87.5 and the document is not automatically saved. In this example, because multiple autosave indicators are combined together to determine the save score 520 the main processor 102 does not automatically save the file even though if only the number of dirty characters were considered, an autosave may have been performed. Consequently, system resources are conserved because the main processor 102 takes into account the typing speed and time since last save indicators and not only the dirty characters indicator.

The foregoing examples highlight how by combining multiple autosave parameters together to determine the save score 520, a flexible and configurable method and system can result that are able to balance and otherwise take into account the competing interests of frequently autosaving files vs. conserving system resources so as to be able to carefully calibrate when files are automatically saved and so as to make relatively efficient use of system resources.

Although the foregoing embodiments primarily discuss use of the example methods depicted in FIGS. 6 to 9 with the mobile device 100, in an alternative embodiment a non-mobile device (not depicted), such as a personal computer, may also implement the methods of FIGS. 6 to 9.

Additionally, although the foregoing embodiments describe determining the various autosave indicators by multiplying together the multipliers 514 and attributes 516, in alternative embodiments different implementations are possible. For example, the main processor 102 may call specific functions designed to return any one or more of the autosave indicators according to a more complex series of operations.

When the document is saved, in one embodiment the entire document is saved and in another embodiment only unsaved changes in the document are saved. Saving only unsaved changes (e.g.: only dirty characters) can reduce the processing, battery, and bandwidth costs of saving.

In the foregoing embodiments the save score 520 is compared to the save threshold, and an autosave is performed if the save score 520 exceeds the save threshold. However, in an alternative embodiment the save score 520 does not have to exceed the save threshold in order for an autosave to occur. For example, an autosave may occur if the save score 520 is equal to the save threshold, if the save score 520 exceeds a certain percentage of the save threshold, if the save score 520 exceeds the result of some other function of the save threshold, or if the save score 520 is less than the save threshold.

The foregoing example embodiments may be encoded on to a computer readable medium that is readable by the main processor 102 or by any other suitably configured controller or processor so as to configure the mobile device 100 to have the functionality described above. The computer readable medium may be the flash memory 108, the RAM 106, or any other suitable disc or semiconductor based memory.

For the sake of convenience, the example embodiments above are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

FIGS. 6 to 9 are flowcharts of example embodiment methods. Some of the steps illustrated in the flowchart may be performed in an order other than that which is described. Also, it should be appreciated that not all of the steps described in the flow chart are required to be performed, that additional steps may be added, and that some of the illustrated steps may be substituted with other steps.

While particular example embodiments have been described in the foregoing, it is to be understood that other embodiments are possible and are intended to be included herein. It will be clear to any person skilled in the art that modifications of and adjustments to the foregoing example embodiments, not shown, are possible.

1. A method for automatically saving a file, the method comprising:
determining a save score for the file from a combination of autosave indicators indicative of whether to immediately autosave the file, wherein each of the autosave indicators that adjust the save score increases or decreases the likelihood that the file will be automatically saved;
comparing the save score to a save threshold to determine whether the file should be automatically saved; and
when the file should be automatically saved, saving the file.

2. A method as claimed in claim 1 wherein the file is being edited using a first mobile device that is connected to a second mobile device on to which the file is saved.

3. A method as claimed in any one of claims 1 and 2 wherein at least one of the autosave indicators comprises an attribute scaled by a multiplier.

4. A method as claimed in any one of claims 1 to 3 wherein the autosave indicator is indicative of a state of the document.

5. A method as claimed in any one of claims 1 to 3 wherein the autosave indicator is indicative of the environment in which the document is being edited.

6. A method as claimed in any one of claims 1 to 5 wherein the save score is scaled by at least one of the autosave indicators.

7. A method as claimed in any one of claims 1 to 6 wherein the save score is incremented or decremented by at least one of the autosave indicators.

8. A method as claimed in any one of claims 1 to 7 wherein at least one of the autosave indicators is independent of a time at which the file was previously saved.

9. A method as claimed in any one of claims 1 to 8 wherein at least one of the autosave indicators is indicative of a number of characters edited in the file since the file was previously saved.

10. A method as claimed in any one of claims 1 to 9 wherein at least one of the autosave indicators is indicative of the type of the file.

11. A method as claimed in any one of claims 1 to 10 wherein at least one of the autosave indicators is indicative of a number of return characters edited in the file since the file was previously saved.

12. A method as claimed in any one of claims 1 to 11 wherein at least one of the autosave indicators is indicative of whether the file is in the foreground of a user interface via which the file can be edited.

13. A method as claimed in any one of claims 1 to 12 wherein at least one of the autosave indicators is indicative of the size of the file.

14. A method as claimed in any one of claims 1 to 13 wherein at least one of the autosave indicators is indicative of a typing speed of a user over a certain period of time.

15. A method as claimed in any one of claims 1 to 14 wherein at least one of the autosave indicators is indicative of a time at which the file was last saved.

16. A method as claimed in any one of claims 1 to 15 wherein at least one of the autosave indicators is indicative of a total age of the file.

17. A method as claimed in any one of claims 1 to 16 wherein at least one of the autosave indicators is indicative of an amount of time that has passed since the last keystroke.

18. A method as claimed in any one of claims 1 to 17 further comprising:
determining whether any dirty characters are present in the file; and
only saving the file when the file has at least one dirty character.

19. A method as claimed in any one of claims 1 to 18 wherein saving the file comprises saving only changes made to the file since the file was last saved.

20. A method as claimed in any one of claims 1 to 19 wherein the save score is determined periodically.

21. A method as claimed in any one of claims 1 to 19 wherein the save score is determined after detection of a keystroke that alters the file.

22. A method as claimed in any one of claims 1 to 11 and 13 to 19 wherein the save score is determined when the file switches between the background and foreground of a user interface via which the file can be edited.

23. A method as claimed in claim 12 wherein the save score is determined when the file switches between the background and foreground of the user interface.

24. A system for automatically saving a file, the system comprising:
a main processor;
a memory communicatively coupled to the main processor on to which the file may be saved, the memory having encoded thereon statements and instructions to configure the main processor to carry out a method as claimed in any one of claims 1 to 23.

25. A system as claimed in claim 24 further comprising a communication subsystem communicable with a mobile device on to which the file may be saved.

26. A computer readable medium having encoded thereon statements and instructions to configure a processor to carry out a method as claimed in any one of claims 1 to 23.
